(19) United States
(12) Patent Application Publication
(10) Pub. No.: US 2002/0042912 A1
(43) Pub. Date: Apr. 11, 2002

(54) Personal taste profile information gathering apparatus

(76) Inventors: Jun Iijima, Tokyo (JP); Ryuichiro Iijima, Tokyo (JP)

Correspondence Address: WENDEROTH, LIND & PONACK, L.L.P., Suite 800, 2033 K. Street, N.W., Washington, DC, 20006, US

(21) Appl. No.: 09/752,716

(22) Filed: Jan. 3, 2001

(30) Foreign Application Priority Data
Oct. 2, 2000 (JP) 2000-302235

(51) Int. Cl. H04N 7/16; H04H 9/00

(52) U.S. Cl. 725/14

(57) ABSTRACT

In order to provide a personal taste profile information gathering apparatus capable of gathering information to be used to ascertain a viewer's personal tastes with a high degree of efficiency without disrupting the viewer's concentration on the media entertainment, a personal taste profile information gathering apparatus 1 that gathers information related to the personal tastes of a viewer viewing a specific type of medium comprises a means for operation G having an operation unit operated by the viewer through a single action and a means for personal taste profile information recording A at which information related to the medium being viewed by the viewer when he operates the means for operation is recorded.

### BACKGROUND OF THE INVENTION

1. Field of the Invention

The present invention relates to an apparatus employed to gather information on personal taste profiles of viewers of various types of media including broadcast media such as broadcast television, the Internet and distributed media such as videotape, DVD and CD-ROM.

2. Description of the Related Art

There are inventions in the prior art implemented to offer functions and services such as automatic program selection and information provision based upon personal taste profiles obtained through analysis of personal taste of the viewer performed by using AV device operating histories and the like. For instance, the broadcast reception apparatus disclosed in Japanese Unexamined Patent Publication No. H 8-180504 automatically selects and indicates a channel which was viewed in the past over a specific time period.

However, while it is possible to ascertain a favorite program of a given a viewer according to the invention in the prior art, a specific character among numerous characters in the program favored by the viewer, for instance, cannot be determined. In addition, while the viewer may input his own personal taste profile throughout a specific input device (a remote control, a personal computer keyboard or the like), the viewer will not be able to fully enjoy the media entertainment if he has to perform such an input operation during viewing and, furthermore, accurate data cannot be obtained if the viewer is not fully aware of his own personal taste. Moreover, it is an extremely difficult task to identify people's personal taste profiles and thus, a large volume of useful information is required to ascertain personal taste profiles.

### SUMMARY OF THE INVENTION

Accordingly, an object of the present invention is to provide a personal taste profile information gathering apparatus which is capable of collecting information to be used to determine a personal taste profile of a viewer in an efficient manner without interrupting his concentration on the media entertainment. In more specific terms, according to the present invention, information required to determine the personal taste profile of the viewer can be collected with efficiency by simplifying the short-time record operation suitable for repeated play and recording the history of the record and play operations based upon a theory that an act of the viewer viewing a given scene repeatedly constitutes highly reliable personal taste information.

In order to achieve the object described above, the personal taste profile information gathering apparatus for gathering information related to the personal tastes of a viewer viewing a specific medium comprises a means for operation that is operated by the viewer through a single action and a means for personal taste profile information recording that records information related to the medium being viewed by the viewer when he operates the means for operation.

In this personal taste profile information gathering apparatus the viewer performs a single-action operation at the means for operation having, for instance, a button-type switch when an image or the like he likes appears on the screen while he views television, a video, the Internet or the like, to record information related to the scene he likes at the means for personal taste profile information recording. Thus, each time the viewer operates the means for operation, data that are useful for ascertaining the viewer's personal taste are gathered. These data, which are used to ascertain the viewer's personal taste profile, may be utilized in the application for offering various functions, services and the like such as automatic program selection and information providing. In addition, since the viewer only needs to perform a simple, single-action operation, his concentration on the entertainment is not interrupted and the operation can become an unconscious habit he engages in while viewing.

The means for personal taste profile information recording may be provided with a scene-specifying data recording unit for recording information used to specify the scene being viewed when the means for operation is operated.

The information used to specify the scene being viewed includes the date/time at which the means for operation is operated, the channel in the case of television, the address (URL) in the case of the Internet and the length of play time elapsed at the point in time at which the means for operation is operated in the case of a distributed medium such as a DVD. These types of information, which enable identification of a scene that interests the viewer, constitute useful data for analyzing the personal tastes of the viewer.

Furthermore, it is desirable to provide at the means for personal taste profile information recording, a contents recording unit for recording the content being viewed when the means for operation is operated.

In such a structure, with the viewer operating the means for operation when a scene or a character he likes is brought up on the screen, for instance, the image, the sound and the like are automatically recorded and stored. Furthermore, it will provide a motivation which will prompt the viewer to operate the operating device.

It is desirable that the contents recording unit be provided with a first means for recording that continuously records the viewing contents concurrently while the viewer views the medium and a second means for recording that records the viewing contents corresponding to the time point at which the means for operation is operated by extracting them from the first means for recording.

In the personal taste profile information gathering apparatus adopting this structure, the viewing contents are recorded in the first means for recording such as a RAM concurrently while the viewer views television, a video, the Internet or the like, and through an operation of the means for operation performed by the viewer, the image and the like corresponding to the time point at which the operation is performed are extracted from the first means for recording to be recorded into the removable recording medium such as a DVD or an MO constituting the second means for recording. As a result, a favorite image, sound and the like are recorded with a high degree of reliability.

The second means for recording may start recording of the viewing contents at a time point preceding the time point at which the means for operation is operated by a specific time length.

The viewer is expected to perform an operation on the means for operation with a slight time lag after the specific image is brought up on the screen. Furthermore, factors such as the limit to the device response speed are bound to cause a delay between the time point at which the viewer decides to record a specific image or the like and the time point at which the actual record operation starts. In order to address the problem of this delay, recording of the image and the like is started at a time point preceding the time point at which the means for operation is operated by a specific time length, e.g., 15 seconds, so that the desired image and the like can be recorded with a high degree of reliability. Moreover, the length of the delay is expected to fluctuate depending upon the mood, the physical condition and so forth of the viewer. Accordingly, a means for adjustment that adjusts the length of time by which the recording start precedes the time point at which the means for operation is operated to an optimal value may be provided.

In addition, data for determining the personal taste profile of the viewer may be prepared and recorded based upon operations performed on the media device.

For instance, operations such as “pause” and “slow play” performed by the viewer while he views a DVD, a video, the Internet or the like are an indication that the scene is of particular interest to the viewer. Thus, by preparing and recording data indicating that the scene during which such a viewer operation is performed is particularly favored by the viewer, the usefulness of the gathered data is enhanced.

Furthermore, the means for operation may be permanently installed at a specific location.

By installing the means for operation at a fixed or semi-fixed position where the viewer's hand or foot can reach, the problem of having to look for the means for operation during viewing is eliminated, thereby achieving an improvement in the operability and making it possible to gather data with a higher degree of ease.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments. In the drawings:

FIG. 1 is a block diagram illustrating the structure of the personal taste profile information gathering apparatus according to the present invention;

FIG. 2 presents an example of the environment in which the personal taste profile information gathering apparatus according to the present invention may be utilized;

FIG. 3 illustrates the structure of the means for operation (personal taste data gathering remote control) employed in the personal taste profile information gathering apparatus according to the present invention;

FIG. 4 shows the structure of the scene-specifying data recording unit utilized in an embodiment of the present invention;

FIG. 5A shows the structure of the contents recording unit utilized in the embodiment, and

FIG. 5B illustrates data extracted from the first recording medium and transferred to the second recording medium at the contents recording unit in FIG. 5A;

FIG. 6 is a flow chart of the control implemented in the personal taste profile information gathering apparatus in the embodiment;

FIG. 7 is a flow chart of the control implemented in the personal taste profile information gathering apparatus in the embodiment; and

FIG. 8 presents an example of the data which may be included in the data at the scene-specifying data recording unit in FIG. 4.

### DETAILED DESCRIPTION OF THE PREFERRED EMBODIMENT

The following is an explanation of an embodiment of the present invention, given in reference to the drawings.

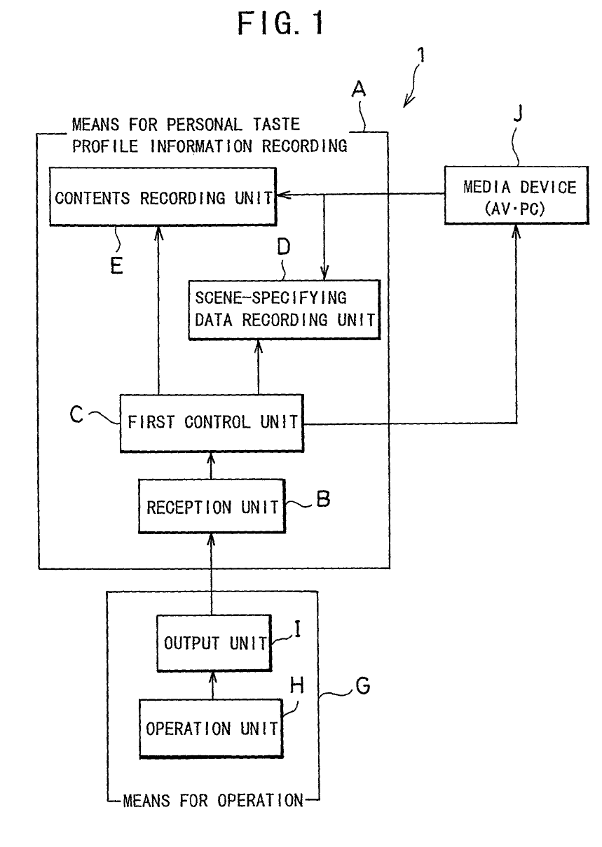

The block diagram in FIG. 1 illustrates the structure of a personal taste profile information gathering apparatus 1 according to the present invention, which comprises a means for personal taste profile information recording A and a means for operation G.

The means for personal taste profile information recording A includes a reception unit B that receives a signal from the means for operation G, a scene-specifying data recording unit D, a contents recording unit E and a first control unit C that outputs a control signal to the scene-specifying data recording unit D, the contents recording unit E and a media device J such as an AV device or a personal computer, based upon the signal received at the reception unit B. The scene-specifying data recording unit D records and stores data for specifying a scene (image, sound and the like) which interests the viewer based upon the signals from the first control unit C and the media device J. The contents recording unit E records the image, the sound and the like in which the viewer has shown an interest based upon the signals from the first control unit C and the media device J.

The means for operation G is constituted of an operation unit H that is operated by the viewer and an output unit I that outputs a signal indicating that the operation unit H has been operated to the reception unit B of the means for personal taste profile information recording A.

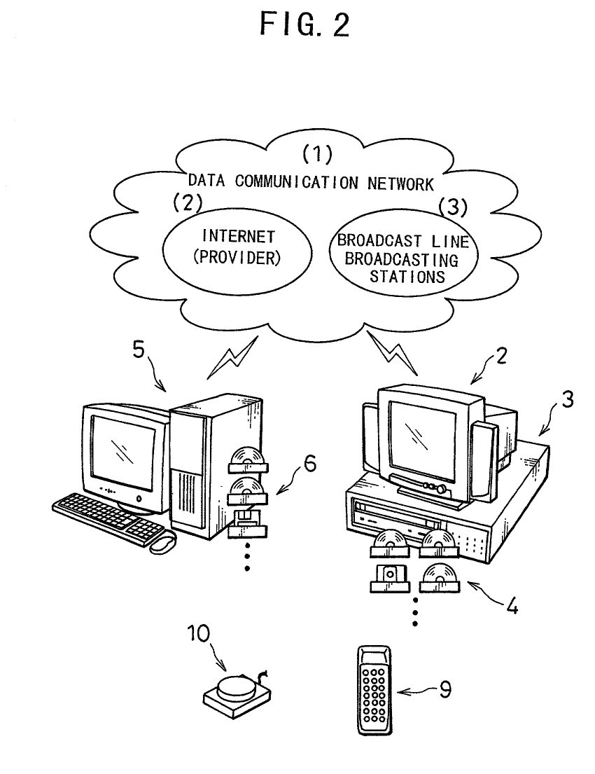

FIG. 2 illustrates an example of the environment in which the personal taste profile information gathering apparatus 1 according to the present invention may be utilized, and this environment includes a television set 2 through which programs constituted of images, sound and the like can be broadcast via ground waves, satellite broadcast waves or a broadcasting line such as a cable, an AV device 3 capable of recording and reproducing the contents of software (recording medium) 4 such as a DVD, a video-CD, a videotape or an LD and a personal computer 5 capable of viewing Web sites and the like via the Internet and also reading/writing (recording) of software (recording medium) 6 such as a CD-ROM, a CD-R or an MO. It further includes an AV operation remote control 9 for performing various operations such as power on/off, volume control and channel change at the television set 2 and the AV device 3 and play/stop, pause and slow play of the recording medium through remote control and a personal taste data gathering remote control 10 constituting the means for operation G.

While the means for personal taste profile information recording A may be constituted of hardware having an independent casing, it may be internally provided at the television set 2, the AV device 3 or the personal computer 5.

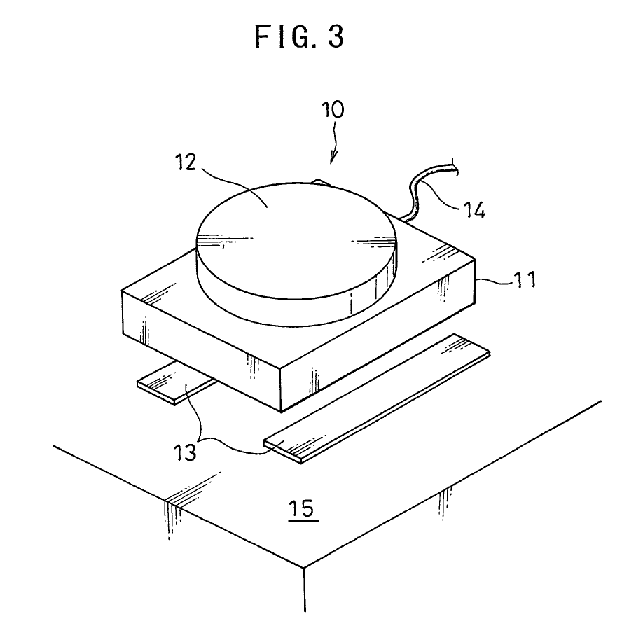

The personal taste data gathering remote control 10 in FIG. 3 is constituted of a base 11, a button 12, a fixing portion 13 and a connecting wire 14. The base 11 is formed in a box shape, with the button 12 provided at its upper surface and a switch mechanism of the known art which interlocks with the button 12 provided within. The switch mechanism outputs an electrical signal to the reception unit B of the means for personal taste profile information recording A via the connecting wire 14 when the button 12 is depressed by the viewer. In addition, at the lower surface of the base 11, the fixing portion 13 for fixing or semi-fixing the entire personal taste data gathering remote control 10 at a specific location 15 of a table or the like is provided. A means for retention comprising two detachable cloth sheets, one with hooks and the other piled, (e.g., the trademark name “Velcro”) or a pressure-sensitive adhesive double-sided tape or the like may be used to constitutes the fixing portion 13.

Alternatively, by giving a specific weight to the personal taste data gathering remote control 10 and thus by making the personal taste data gathering remote control 10 stationary, it is possible to dispense with the fixing portion 13. In addition, the personal taste data gathering remote control 10 may be placed by the foot of the viewer to enable foot operation.

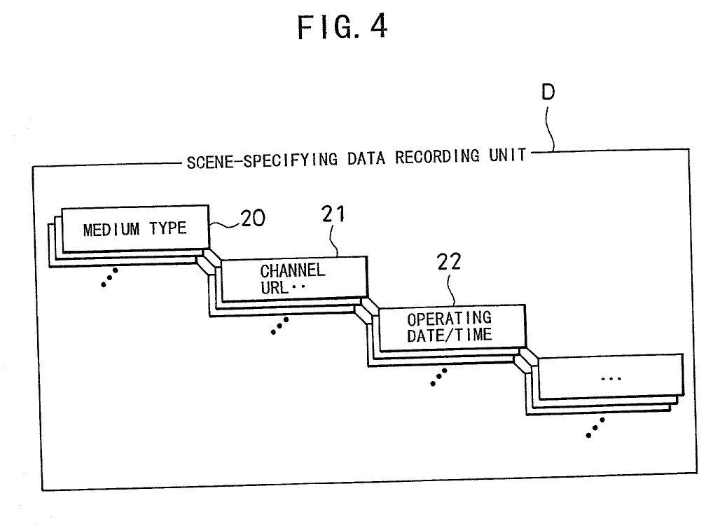

At the scene-specifying data recording unit D shown in FIGS. 1 and 4, data for specifying the scene (image, sound and the like) being viewed by the viewer at the time point at which the scene-specifying data recording unit D is operated are recorded based upon a signal from the television set 2 or the media device J such as the AV device 3 or the personal computer 5 when a signal is output from the means for operation G (the personal taste data gathering remote control 10), as described above. As illustrated in FIG. 4, at the scene-specifying data recording unit D, data 20 for identifying the type of medium (television, DVD, Internet, CD-ROM or the like) being viewed at the time point at which the button 12 (see FIG. 3) is pressed, detailed data 21 for identifying the scene being viewed, i.e., the channel in the case of television, the web site address (URL) in the case of the Internet, the length of play time that has elapsed when the scene which prompts the viewer to press the button 12 comes up in the case of a distributed medium such as a DVD and the like, data 22 indicating the time/date at which the button 12 is pressed and other useful data are recorded and stored in correspondence to one another.

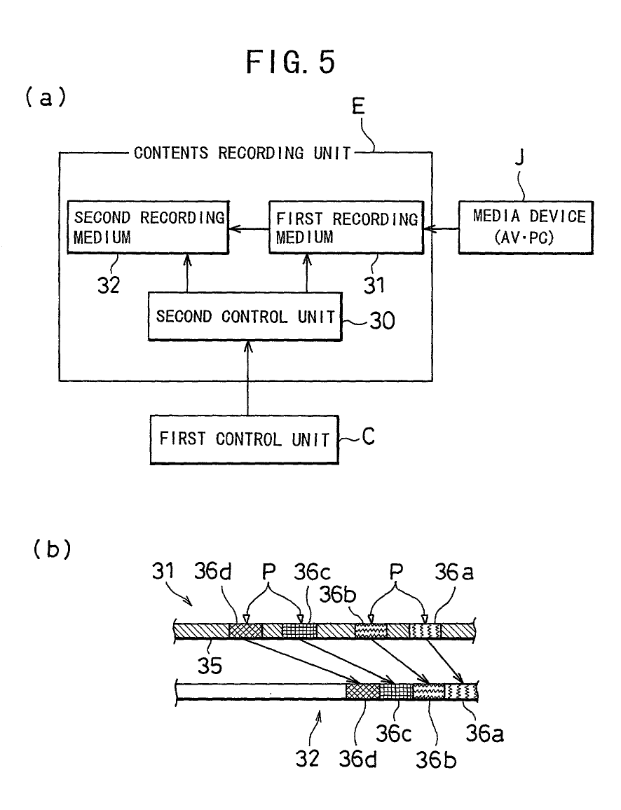

The contents recording unit E shown in FIGS. 1 and 5A, at which an image, sound and the like that the viewer has shown an interest in are recorded in conformance to a control signal issued by the first control unit C as described above, may be constituted of a first recording medium 31 such as a hard disk, a second recording medium 32 which is a removable recording medium such as a DVD, an MO or a videotape and a second control unit 30 that extracts specific recorded data from the first recording medium 31 and transfers them to the second recording medium 32 in response to the signal from the first control unit C.

As illustrated in FIG. 5B, the transfer of data from the first recording medium 31 to the second recording medium 32 is achieved by extracting sets of data 36a, 36b, 36c and 36d each corresponding to, for instance, a 15-second period starting at a time point preceding a time point P at which the button 12 of the personal taste data gathering remote control 10 is pressed and ending at a time point following the time point P from the entire contents of data 35 recorded at the first recording medium 31 and transferring the sets of data 36a, 36b, 36c and 36d to the second recording medium 32. As a result, images and the like on the medium that interest the viewer are cumulatively stored at the second recording medium 32 such as a DVD or an MO.

It is to be noted that while the 15-second period starting at a time point preceding the time point P at which the button 12 is pressed and ending at a time point following the time point P is set by taking into consideration a delay occurring after the viewer decides to record a scene before the actual record operation is started, the length of this period should be adjustable and it may be automatically set by a specific control program at the second control unit 30.

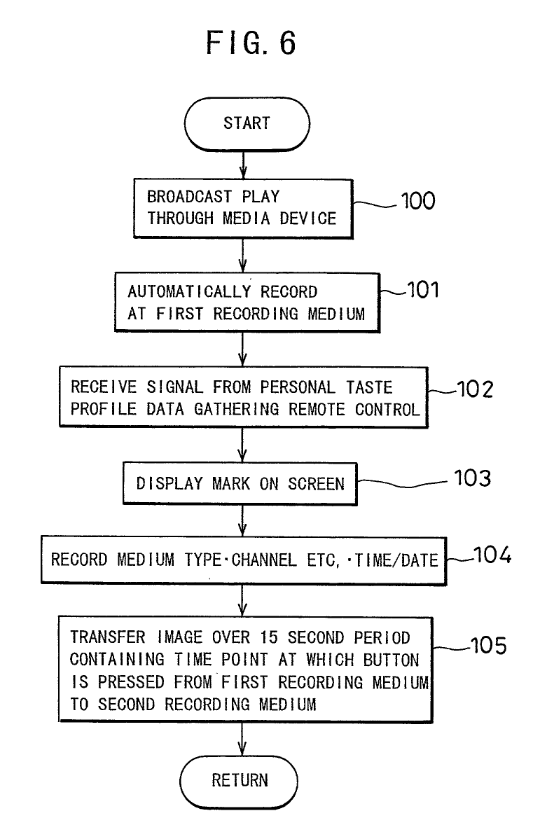

The following is an explanation of an example of the control implemented in the personal taste profile information gathering apparatus 1 structured as described above, given in reference to the flow chart in FIG. 6. First, as the viewer starts watching a program broadcast on the television set 2, playing a DVD on the AV device 3 or viewing a web site on the Internet on the personal computer 5 in step 100, a record operation to record the entire contents on the medium being viewed by the viewer at the first recording medium 31 of the contents recording unit E starts in step 101. At this time, the contents are placed in a loop memory so that the record operation can be continued even if the storage capacity of the first recording medium 31 becomes fill.

Then, when a scene that the viewer likes appears on the medium and the viewer presses the button 12 of the personal taste data gathering remote control 10, the reception unit B receives a signal in step 102, a mark indicating that the button 12 has been pressed is displayed on the television screen or the computer display in step 103 and the type of medium being viewed, the channel—URL—length of play time elapsed, the date/time at which the button 12 is pressed and the like are recorded in correspondence to one another at the scene-specifying data recording unit D in step 104. Next, in step 105, the image and the like over the 15-second period starting at a time point preceding the time point at which the button 12 was pressed and ending at a time point following the time point at which the button 12 was pressed are extracted from the first recording medium 31 and are transferred to the second recording medium 32.

In the structure described above, if a scene that the viewer likes appears while the viewer is viewing a specific medium, the viewer presses the button 12 of the personal taste data gathering remote control 10 once to record the information for specifying the scene in the scene-specifying data recording unit D (see FIG. 4) and to record the image and the like on display at the time point at the second recording medium 32. By performing this operation repeatedly, data which are useful for determining the viewer's personal taste profile and images and the like that suit the viewer's taste are automatically stored. In addition, by simplifying the operation of the personal taste data gathering remote control 10 and installing the personal taste data gathering remote control 10 at a fixed position near the viewer's hand or foot, the personal taste data gathering remote control 10 can be operated without disrupting the viewer's concentration on the medium. Consequently, the operation can become a habitual action that the viewer engages in while enjoying the media entertainment.

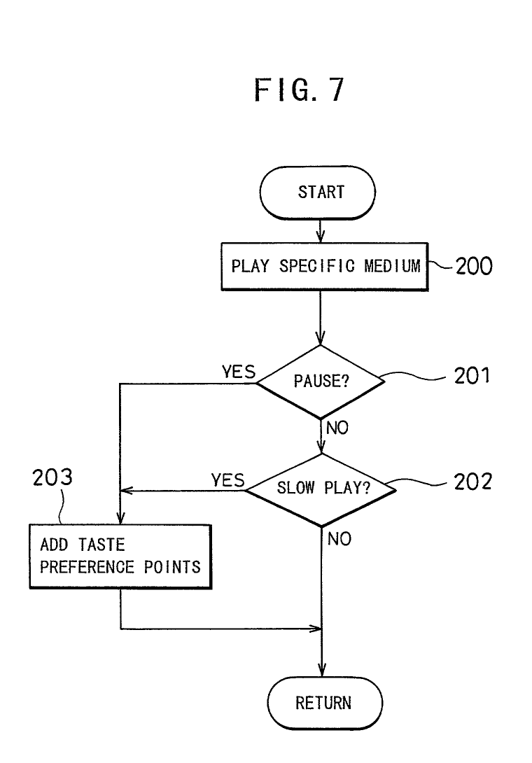

In addition, it is possible to gather other data related to personal tastes in conjunction with media such as DVD, a videotape and LD, based upon operations performed through the AV operation remote control 9 or the like while viewing (playing back) the media. The following is an explanation of an example of the control implemented in such an instance, given in reference to the flow chart in FIG. 7.

As a specific medium is played back in step 200, a decision is made in step 201 as to whether or not a “pause” operation has been performed through the AV operation remote control 9 or the like, and if a “pause” operation has been performed, points indicating a specific degree of taste preference are added in step 203.

If, on the other hand, it is decided in step 201 that a “pause” operation has not been performed, a decision is made in step 202 as to whether or not a “slow play” operation has been performed, and if a “slow play” operation has been performed, points indicating a specific degree of taste preference are added in step 203. If it is decided in step 202 that a “slow play” operation has not been performed, the operation exits this control routine to return to the other routine.

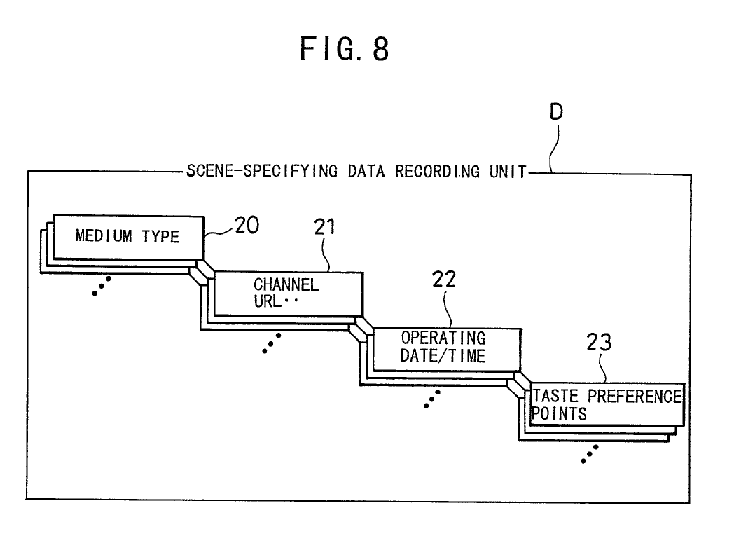

To achieve the control described above, points (taste preference points) 23 indicating the degree of taste preference should be included in the data stored at the scene-specifying data recording unit D, as shown in FIG. 8. For instance, if a scene is determined to indicate to a high degree of taste preference, high points are added as the taste preference points 23.

Through the control described above, data indicating a high degree of taste preference can be stored for a scene which prompts a “pause” or a “slow play” operation. Thus, the viewer's personal taste can be profiled even more accurately.

As explained above, according to the present invention, information for ascertaining the viewer's personal taste profile can be gathered with efficiency without disrupting the viewer's concentration on the media entertainment.

What is claimed is:

1. A personal taste profile information gathering apparatus for gathering information related to the personal tastes of a viewer viewing a specific medium comprising:
a means for operation that is operated by the viewer through a single action; and
a means for personal taste profile information recording that records information related to the medium being viewed by the viewer when the viewer operates said means for operation.

2. A personal taste profile information gathering apparatus according to claim 1, wherein:
said means for personal taste profile information recording is provided with a scene-specifying data recording unit for recording information used to specify a scene being viewed when said means for operation is operated.

3. A personal taste profile information gathering apparatus according to claim 1, wherein:
said means for personal taste profile information recording unit is provided with a contents recording unit for recording the contents being viewed when said means for operation is operated.

4. A personal taste profile information gathering apparatus according to claim 2, wherein:
said means for personal taste profile information recording unit is provided with a contents recording unit for recording the contents being viewed when said means for operation is operated.

5. A personal taste profile information gathering apparatus according to claim 3, wherein:
said contents recording unit is provided with a first means for recording that continuously records the viewing contents concurrently while the viewer views the medium and a second means for recording that extracts and records the viewing contents corresponding to a time point at which said means for operation is operated from said first means for recording.

6. A personal taste profile information gathering apparatus according to claim 4, wherein:
said contents recording unit is provided with a first means for recording that continuously records the viewing contents concurrently while the viewer views the medium and a second means for recording that extracts and records the viewing contents corresponding to a time point at which said means for operation is operated from said first means for recording.

7. A personal taste profile information gathering apparatus according to claim 5, wherein:
said second means for recording starts recording of the viewing contents at a time point preceding the time point at which said means for operation is operated by a specific time length.

8. A personal taste profile information gathering apparatus according to claim 6, wherein:
said second means for recording starts recording of the viewing contents at a time point preceding the time point at which said means for operation is operated by a specific time length.

9. A personal taste profile information gathering apparatus according to claim 1, wherein:
data for determining the personal tastes of the viewer are prepared and recorded based upon operations performed on a media device.

10. A personal taste profile information gathering apparatus according to claim 1, wherein:
said means for operation can be permanently installed at a specific location.

11. A personal taste profile information gathering apparatus according to claim 2, wherein:
data for determining the personal tastes of the viewer are prepared and recorded based upon operations performed on a media device.

12. A personal taste profile information gathering apparatus according to claim 2, wherein:
said means for operation can be permanently installed at a specific location.

13. A personal taste profile information gathering apparatus according to claim 3, wherein:
data for determining the personal tastes of the viewer are prepared and recorded based upon operations performed on a media device.

14. A personal taste profile information gathering apparatus according to claim 3, wherein:
said means for operation can be permanently installed at a specific location.

15. A personal taste profile information gathering apparatus according to claim 4, wherein:
data for determining the personal tastes of the viewer are prepared and recorded based upon operations performed on a media device

16. A personal taste profile information gathering apparatus according to claim 4, wherein:
said means for operation can be permanently installed at a specific location.

17. A personal taste profile information gathering apparatus according to claim 5, wherein:
data for determining the personal tastes of the viewer are prepared and recorded based upon operations performed on a media device

18. A personal taste profile information gathering apparatus according to claim 5, wherein:
said means for operation can be permanently installed at a specific location.

19. A personal taste profile information gathering apparatus according to claim 6, wherein:
data for determining the personal tastes of the viewer are prepared and recorded based upon operations performed on a media device

20. A personal taste profile information gathering apparatus according to claim 6, wherein:
said means for operation can be permanently installed at a specific location.

21. A personal taste profile information gathering apparatus according to claim 7, wherein:
data for determining the personal tastes of the viewer are prepared and recorded based upon operations performed on a media device

22. A personal taste profile information gathering apparatus according to claim 7, wherein:
said means for operation can be permanently installed at a specific location.

23. A personal taste profile information gathering apparatus according to claim 8, wherein:
data for determining the personal tastes of the viewer are prepared and recorded based upon operations performed on a media device

24. A personal taste profile information gathering apparatus according to claim 8, wherein:
said means for operation can be permanently installed at a specific location.
